(19) United States
(12) Patent Application Publication
(10) Pub. No.: US 2009/0073532 A1
(43) Pub. Date: Mar. 19, 2009

(54) SCANNER ACTUATING DEVICE

(75) Inventors: In-Jae Yeo, Yongin-si (KR); Hyun-Phill Ko, Seongnam-si (KR); Gi-Young Byun, Incheon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/055,109

(22) Filed: Mar. 25, 2008

(30) Foreign Application Priority Data
Sep. 19, 2007 (KR) 10-2007-0095281

(51) Int. Cl. G02B 26/10; H02N 2/04

(52) U.S. Cl. 359/226; 310/323.16

(57) ABSTRACT

A scanner actuating device is disclosed. According to an embodiment of the present invention, the scanner actuating device can include a piezo actuator, which includes a plurality of piezo elements, which are contracted or expanded, and a friction contact part, which moves in an elliptic motion according to the contraction or expansion of the piezo element, a friction bar, which converts the elliptic movement into a straight-line movement and is protruded toward a different direction from the direction of the straight-line movement, a rotation member, which includes a sliding contact part moving with the straight-line movement of the sliding contact part, the sliding contact part, which rotates about a settled axis, and a scanning mirror, which is mounted on the rotation member and reflecting an incident beam of light in a desired direction by rotating about the rotation axis.

### CROSS-REFERENCE TO RELATED APPLICATION

This application claims the benefit of Korean Patent Application No. 10-2007-0095281, filed on Sep. 19, 2007, in the Korean Intellectual Property Office, the disclosure of which is incorporated herein in its entirety by reference.

### BACKGROUND

1. Field of the Invention

The present invention relates to a scanner actuating device, more specifically to a scanner actuating device which rotates a canning mirror at a predetermined actuating angle by using a piezo actuator.

2. Background Art

A conventional scanner actuating device needs highly precise symmetry in the shape of a tip part (or a contact part) of a piezo actuator in order to allow a scanning mirror to be driven by the piezo actuator. Also, a rotation axis of the scanning mirror must be exactly perpendicular to other parts.

FIG. 1 illustrates a conventional scanner actuating device. The scanner actuating device illustrated in FIG. 1 includes a piezo actuator 110, a tip 120, a rotor 130, a rotation axis 140, a scanning mirror 150 and a spring 160.

In the conventional scanner actuating device, friction is produced between the rotor 130 and the tip 120 mounted on a lateral side of the piezo actuator 110 as the piezo actuator 110 is operated. The rotation of the rotor 130, on which friction is produced by the tip 120, causes the scanning mirror 150, settled on the rotor 130 about the rotation axis 140, to be actuated.

The piezo actuator 110 illustrated in FIG. 1 includes two piezo elements 112 and 114. Here, the two piezo elements 112 and 114 are arranged perpendicularly to each other. The tip 130 placed on the intersection of the two piezo elements 112 and 114 can be allowed to move in elliptic motion or circular motion by the repeated expansion or contraction of each of the two piezo elements 112 and 114.

The scanner actuating device can further include the spring 160, which is placed opposite to the tip 120, in the piezo actuator 110. Accordingly, the spring 160 can adjust the magnitude of pressure which the tip 120 applies to the rotor 130.

In this case, the spring 160, the piezo actuator 110, the tip 120 and the rotor 130 must be precisely assembled in a line in order to allow the tip 120 to apply a precise pressure on the rotor 130. Further, the rotor 130 is required to be exactly vertical to the rotation axis 140 and also is required to be assembled to be exactly perpendicular to an actuating direction of the piezo actuator 110.

Since the tip 120 moves in an elliptic motion by the expansion and contraction of the two piezo elements 112 and 114 in their vertical and horizontal directions only, it is difficult to expand a movement locus. This may also cause the actuating angle of the scanning mirror 150 to be narrower.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a scanner actuating device that can allow a scanning mirror to be capable of rotating within a wide range of an actuating angle.

The present invention also provides a scanner actuating device that can precisely control an actuating angle of a scanning mirror.

The present invention also provides a scanner actuating device that can reduce power consumption.

In addition, the present invention provides a scanner actuating device that can be exactly moved without being easily affected by an error generated when the scanner actuating device is assembled.

According to an aspect of the present invention, there is provided a scanner actuating device including a piezo actuator, including a plurality of piezo elements, which are contracted or expanded, and a friction contact part, which moves in an elliptic motion according to the contraction or expansion of the piezo element; a friction bar, converting the elliptic movement into a straight-line movement by a friction with the friction contact part and including a sliding contact part protruded toward a different direction from the direction of the straight-line movement; a rotation member, moving with the straight-line movement of the sliding contact part but rotating about a settled rotation axis; and a scanning mirror, mounted on the rotation member and reflecting an incident beam of light in a desired direction by rotating about the rotation axis.

Here, the rotation member can include a hollow accommodation groove that accommodates the sliding contact part.

At this time, the sliding contact part can be in contact with an inside wall of the accommodation groove, and the rotation member can rotate according to the straight-line movement of the sliding contact part.

Also, the rotation member can be settled in an end part of a side area of the sliding mirror, and the rotation axis can be included in the scanning mirror.

Here, the rotation member can include the rotation axis, and the scanning mirror can be settled on a side of the rotation axis in a direction in parallel with the rotation axis.

Here, the device can further include a pressure providing part, providing predetermined pressure to the piezo actuator to allow the friction contact part to be in contact with or separated from the friction bar.

Also, the piezo actuator can be actuated according to an electric signal.

Alternatively, the friction bar can include a friction surface, producing friction between the friction surface and the friction contact part, whereas the friction surface can be placed on a surface, the surface being one of surfaces included in the friction bar, the surface being placed on a level with a surface on which the sliding contact part is provided.

Alternatively, the friction bar can include a friction surface, producing friction between the friction surface and the friction contact part, whereas the friction surface can be placed on a surface, the surface being one of surfaces included in the friction bar, the surface being placed on a different level from a surface on which the sliding contact part is provided.

Also, the piezo actuator can include 4 piezo elements coupled as 2 pairs, and the piezo actuator can be actuated by contraction and expansion, the contraction and expansion being made by a pair of diagonally-placed piezo elements and the remaining pair of piezo elements, respectively.

Also, the friction contact part can repeat a predetermined number of elliptic movements; the sliding contact part can move in a straight-line motion by the repeated elliptic movements of the friction contact part; and the rotation member can rotate in accordance with a distance by which the sliding contact part moved in the straight-line motion.

Here, the device can further include a guide part guiding the friction bar to move in the straight-line motion within a predetermined path.

Here, the piezo actuator can include at least two friction contact parts.

Here, the device can further include N piezo actuators, N being a natural number.

Also, the friction contact part can have a spherical or cylinder shape.

Here, the friction surface can be either flat or curved.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

These and other features, aspects and advantages of the present invention will become better understood with regard to the following description, appended claims and accompanying drawings where:

FIG. 1 illustrates a conventional scanner actuating device;

FIG. 2 illustrates a scanner actuating scanner in accordance with an embodiment of the present invention;

FIGS. 3A through FIG. 3C illustrate the movement of a piezo actuator of a scanner actuating device in accordance with an embodiment of the present invention; and

FIGS. 4A through FIG. 4C illustrate the rotation of a scanning mirror in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, some embodiments of the present invention will be described in detail with reference to the accompanying drawings.

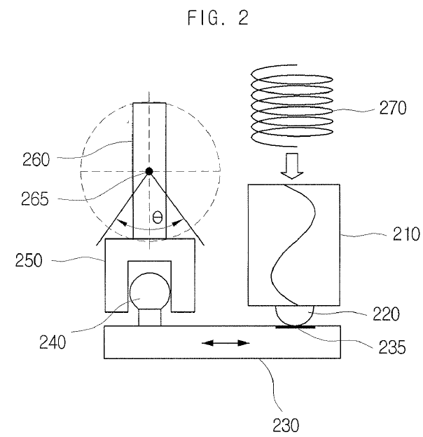

FIG. 2 illustrates a scanner actuating device in accordance with an embodiment of the present invention.

The scanner actuating scanner in accordance with an embodiment of the present invention can include a piezo actuator 210, a friction bar 240, a rotation member 250, moving according to the movement of the friction bar 240, and a scanning mirror 260, settled in the rotation member 250.

Here, the piezo actuator 210 can include a friction contact part 220. The friction bar 230 can include a sliding contact part 240 and a friction surface 235, where the friction bar 230 contacts the friction contact part 220. The rotation member 250, which is moved by the movement of the sliding contact part 240 protruded from the friction bar 230, can rotate about a settled rotation axis. The rotation axis can be included inside or outside the rotation member 250.

The scanner actuating device can further include a pressure providing part 270 for adjusting the pressure which the friction contact part 220 applies to the friction bar 230. The pressure providing part 270 can be a spring, for example. The friction contact part 220 can be in contact with or separated from the friction surface 235 according to the magnitude of the pressure provided by the pressure providing part 270. When the friction contact part 220 is in contact with the friction surface 235, the pressure level can be also adjusted.

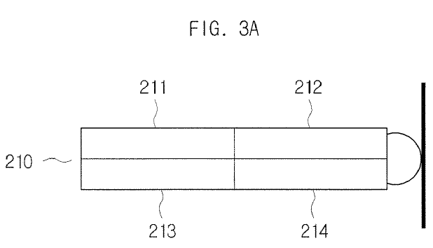

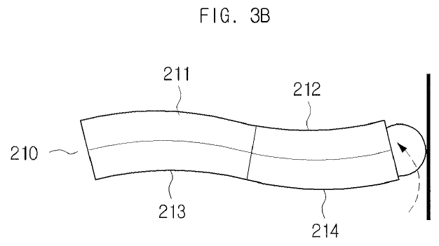

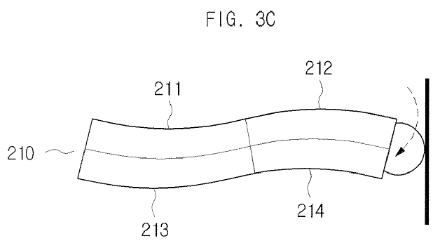

The piezo actuator 210 can include a plurality of piezo elements. The piezo elements can be expanded or contracted according to an applied voltage. Changing the expansion or contraction of the piezo elements can result in the change of position and direction of the friction contact part 220 mounted on an end area of the piezo actuator 210. The operation of the piezo elements will be described in more detail with reference to FIG. 3.

The expansion and contraction of the piezo element can make it possible for the friction contact part 220, mounted on an end area of the piezo actuator 210, to move in a circular or elliptic motion. Here, the piezo actuator 210 can include at least one friction contact part 220.

The friction contact part 220 can allow the friction bar 230 to move in a straight-line motion in a certain direction. In other words, when the friction contact part 220 moves in the elliptic motion in a specific direction, if the friction contact part 220 is allowed to contact the friction bar 230 by adjusting the magnitude or timing of the pressure which the pressure providing part 270 applies to the friction contact part 220, the friction bar 230 can be allowed to move as much as a predetermined distance.

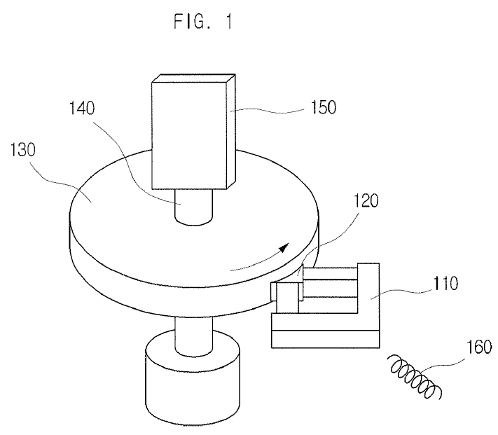

Also, the friction contact part 220 can apply pressure to the friction bar 230 in the vertical direction and use a horizontal component of the elliptic motion for the straight-line motion. Accordingly, the movement of the scanning mirror 260 does not react sensitively to an error generated during a process or an assembling operation. Referring to FIG. 1, since the conventional scanner actuating device requires the circular shaped rotor 130 to apply pressure to the tip 120, the direction of the applied pressure must be exactly identical to that of the radius of the rotor 130. Accordingly, the process error affects greatly on the movement of the scanning mirror 150.

On the other hands, since the embodiment of the present invention needs low-level process precision or assembling precision which is necessary for the operation of the scanner actuating device, the reliability or productivity of the device can be improved.

The direction of the elliptic motion of the friction contact part 220, however, is changeable depending on various factors such as the process error. Also, there may be an error in the direction of the straight-line motion of the friction bar 230.

In this case, the friction bar 230 moves in a straight-line motion in a different direction from a predetermined direction. The change of the direction of the straight-line of the friction bar 230 causes the efficiency of the movement of the scanning mirror 260 to be lower. Accordingly, the scanner actuating device can further include a guide part (not shown) guiding the friction bar 230 to move in a straight-line motion within a certain path. The guide part can function as a support restricting the path to allow the friction bar 230 not to go out of the predetermined path.

Referring to FIG. 1, in the case of the conventional art, since the surface being in contact with the tip 120 is the convex curved surface, if the shape of tip 120 became asymmetric due to the abrasion of the tip 120 or the process error, the big difference of the actuating angle of the scanning mirror 150 might occur according to the actuating direction as compared with the case that the surface being in contact with the tip 120 is a flat surface.

On the other hands, in the case of the scanner actuating device in accordance with an embodiment of the present invention, since the refraction surface 235 contacted by the refraction contact part 220 is flat, the actuating angle of the scanning mirror 260 is little affected by whether the shape of the friction contact part 220 is symmetry.

Not every embodiment of the present invention, however, is limited to the case that the friction surface 235 of the friction bar 230 is flat. For various purposes, the friction surface 235 can have a curved-surface shape. Also, if viewed from the direction of the friction contact part 220, the friction surface 235 can have a convex or concave curved-surface.

While the description with reference to FIG. 2 is based on the example of the case of the spherical or semi-spherical friction contact part 220, the friction contact part 220 in accordance with various embodiments of the present invention can have a variety of shapes (or polyhedrons), including the spherical and semi-spherical types.

The scanner actuating device can include at least two piezo actuators 210.

The elliptical motion of the piezo actuator 210 can be converted into a straight-line motion of the friction bar 230. While transferred to the rotation member 250 through the sliding contact part 240, the straight-line motion of the friction bar 230 can be converted into a rotation motion. The rotation member 250, described above, can be moved by the straight-line motion of the sliding contact part 240 which is protruded from the friction bar 240.

The rotation member 250 can have a hollow accommodation groove. The accommodation groove of the rotation member 250 can accommodate the sliding contact part 240. Accordingly, in the state where the accommodation groove accommodates the sliding contact part 240 and the sliding contact part 240 is in contact with the inside wall of the accommodation groove, if the sliding contact part 240 moves, the rotation member 250 can be rotated according to the straight-line motion of the sliding contact part 240.

Here, the rotation member 250 can be shaped like a plate that includes a rotation axis inside. In this case, the scanning mirror 260 can be mounted on the rotation member 250. At this time, the rotation member 250 can have a similar shape to the rotor 130 of FIG. 1.

Alternatively, as illustrated in FIG. 2, the rotation member 250 can be settled in an end part of a side area of the scanning mirror 260. In such a case, the rotation axis of the rotation member 250 can be outside the rotation member 250, and can be included in the scanning mirror 260.

The rotation of the rotation member 250 can lead to the movement of the scanning mirror 260 within the actuating angle θ. The actuating angle can be controlled by adjusting the pressure applied to the friction surface 235 by the friction contact part 220 according to the pressure providing part 270. Accordingly, the scanning mirror 260 can reflect an emitted beam of light to a desired direction.

FIG. 3A through FIG. 3C illustrate the movement of a piezo actuator of a scanner actuating device in accordance with an embodiment of the present invention. FIG. 3A illustrates the state of the piezo actuator 210 before moving, and FIGS. 3B and 3C illustrate the movement of the piezo actuator 210 by the expansion or contraction of piezo elements 211, 212, 213 and 214.

In accordance with an embodiment of the present invention, the piezo actuator 210 can include 4 piezo elements 211, 212, 213 and 214. As illustrated in FIGS. 3A through FIGS. 3C, a pair of diagonally-placed piezo elements 211 and 214 or 212 and 213 of 4 piezo elements 211, 212, 213 and 214 are expanded or contracted together. FIG. 3B illustrates the piezo actuator 210 in which the piezo elements 211 and 214 are expanded and the piezo elements 212 and 213 are contracted. FIG. 3C illustrates the piezo actuator 210 in which the piezo elements 212 and 213 are expanded and the piezo elements 211 and 214 are contracted.

The description with reference to FIGS. 3A through 3C is based on the embodiment that the piezo actuator 210 is moved by one set of 4 piezo elements 211, 212, 213 and 214. In accordance with another embodiment of the present invention, the piezo actuator 210 can be moved by coupling a plurality of sets consisting of the piezo elements in series or in parallel. Also, the number of piezo elements included in one set is not necessarily limited to 4.

As described above, if the piezo actuator 210 is moved by the expansion and contraction of piezo elements 211, 212, 213 and 214, the friction contact part 220 mounted in an end part of the piezo actuator 210 moves in a circular or elliptic motion.

In other words, if the piezo actuator 210 moves in the order of FIG. 3A, FIG. 3B and FIG. 3A or FIG. 3A, FIG. 3C and FIG. 3A, the friction contact part 220 moves in a circular or elliptic motion clockwise and counterclockwise, respectively. The contact of the elliptically moved friction contact part 220 and the friction surface 235 leads to a straight-line motion of the friction bar 230.

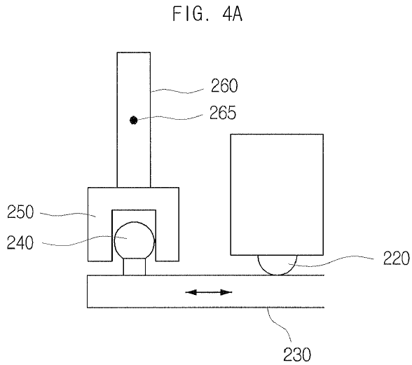

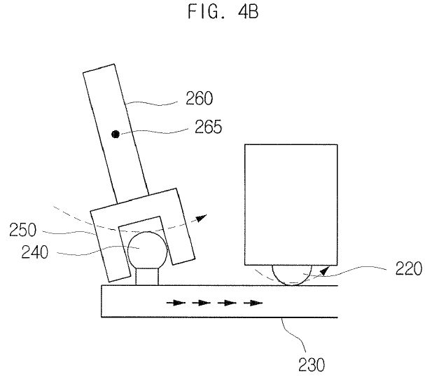

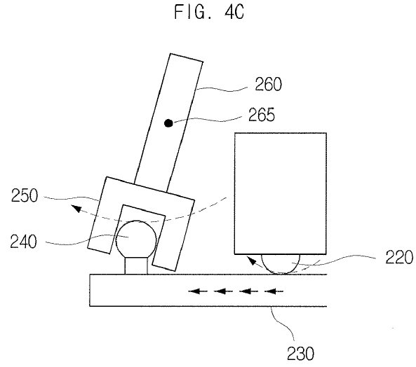

FIG. 4A through FIG. 4C, which illustrate the rotation of a scanning mirror in accordance with an embodiment of the present invention, show a part of a scanner actuating device. FIG. 4A illustrates a part of the scanner actuating device before the scanning mirror 260 rotates. FIG. 4B illustrates the clockwise rotation of the scanning mirror 260 about the rotation axis 265. FIG. 4C illustrates the counterclockwise rotation of the scanning mirror 260 about the rotation axis 265.

In particular, FIG. 4B illustrates that the counterclockwise elliptic (or circular) movement of the friction contact part 220 is performed several times according to the movement of the piezo actuator 210. The friction bar 230 moves to the right side by the contact with the friction contact part 220, which moves counterclockwise. If the friction bar 230 moves to the right side, the sliding contact part 240 also moves to the right side, and similarly, the rotation member 250, the movement of which is subordinate to the movement direction of the sliding contact part 240, also moves to the right side.

The rotation member 250 is settled in an end part of the scanning mirror 260 assembled in the rotation axis 265. As a result, as the friction bar 230 moves to the right side, the scanning mirror 260 is rotated counterclockwise.

Similarly, if the friction contact part 220 is rotated clockwise, the scanning mirror 260 is also rotated clockwise.

Particularly, FIG. 4C illustrates that the clockwise elliptic (or circular) movement of the friction contact part 220 is performed several times according to the movement of the piezo actuator 210. The friction bar 230 moves to the left side by the contact with the friction contact part 220, which moves clockwise. If the friction bar 230 moves to the left side, the sliding contact part 240 also moves to the left side, and similarly, the rotation member 250, the movement of which is subordinate to the movement direction of the sliding contact part 240, also moves to the left side. The rotation member 250 is settled in an end part of the scanning mirror 260 assembled in the rotation axis 265. As a result, as the friction bar 230 moves to the left side, the scanning mirror 260 is rotated clockwise.

Although some embodiments of the present invention have been described, anyone of ordinary skill in the art to which the invention pertains should be able to understand that a very large number of permutations are possible without departing the spirit and scope of the present invention and its equivalents, which shall only be defined by the claims appended below.

While illustrative embodiments have been illustrated and described, it will be appreciated that various changes can be made therein without departing from the spirit and scope of the invention.

The embodiments of the invention in which an exclusive property or privilege is claimed are defined as follows:

1. A scanner actuating device, comprising:
a piezo actuator, including a plurality of piezo elements, which are contracted or expanded, and a friction contact part, which moves in an elliptic motion according to the contraction or expansion of the piezo element;
a friction bar, converting the elliptic movement into a straight-line movement by a friction with the friction contact part and including a sliding contact part protruded toward a different direction from the direction of the straight-line movement;
a rotation member, moving with the straight-line movement of the sliding contact part but rotating about a settled rotation axis; and
a scanning mirror, mounted on the rotation member and reflecting an incident beam of light in a desired direction by rotating about the rotation axis.

2. The device of claim 1, wherein the rotation member comprises a hollow accommodation groove that accommodates the sliding contact part.

3. The device of claim 2, wherein the sliding contact part is in contact with an inside wall of the accommodation groove, and the rotation member rotates according to the straight-line movement of the sliding contact part.

4. The device of claim 1, wherein the rotation member is settled in an end part of a side area of the sliding mirror, and the rotation axis is included in the scanning mirror.

5. The device of claim 1, wherein the rotation member comprises the rotation axis, and the scanning mirror is settled on a side of the rotation axis in a direction in parallel with the rotation axis.

6. The device of claim 1, further comprising a pressure providing part, providing predetermined pressure to the piezo actuator to allow the friction contact part to be in contact with or separated from the friction bar.

7. The device of claim 1, wherein the piezo actuator is actuated according to an electric signal.

8. The device of claim 1, wherein the friction bar comprises a friction surface, producing friction between the friction surface and the friction contact part,
whereas the friction surface is placed on a surface, the surface being one of surfaces included in the friction bar, the surface being placed on a level with a surface on which the sliding contact part is provided.

9. The device of claim 1, wherein the friction bar comprises a friction surface, producing friction between the friction surface and the friction contact part,
whereas the friction surface is placed on a surface, the surface being one of surfaces included in the friction bar, the surface being placed on a different level from a surface on which the sliding contact part is provided.

10. The device of claim 1, wherein the piezo actuator comprises 4 piezo elements coupled as 2 pairs, and the piezo actuator is actuated by contraction and expansion, the contraction and expansion being made by a pair of diagonally-placed piezo elements and the remaining pair of piezo elements, respectively.

11. The device of claim 1, wherein the friction contact part repeats a predetermined number of elliptic movements;
the sliding contact part moves in a straight-line motion by the repeated elliptic movements of the friction contact part; and
the rotation member rotates in accordance with a distance by which the sliding contact part moved in the straight-line motion.

12. The device of claim 1, further comprising a guide part guiding the friction bar to move in the straight-line motion within a predetermined path.

13. The device of claim 1, wherein the piezo actuator comprises at least two friction contact parts.

14. The device of claim 1, further comprising N piezo actuators, N being a natural number.

15. The device of claim 1, wherein the friction contact part has a spherical or cylinder shape.

16. The device of claim 1, wherein the friction bar comprises a friction surface, producing friction between the friction surface and the friction contact part, and the friction surface is either flat or curved.
